(19) United States
(12) Patent Application Publication
(10) Pub. No.: US 2013/0165180 A1
(43) Pub. Date: Jun. 27, 2013

(54) Integrating Operation Of Consumer Electronic Devices

(71) Applicants: Yohko Aurora Fukuda Kelley, Woodinville, WA (US); Kim Pascal Pimmel, San Francisco, CA (US); Matthew Soper Snow, San Rafael, CA (US)

(72) Inventors: Yohko Aurora Fukuda Kelley, Woodinville, WA (US); Kim Pascal Pimmel, San Francisco, CA (US); Matthew Soper Snow, San Rafael, CA (US)

(73) Assignee: ADOBE SYSTEMS INCORPORATED, San Jose, CA (US)

(21) Appl. No.: 12/891,604

(22) Filed: Sep. 27, 2010

(51) Int. Cl. H04M 1/00; G05B 19/02

(52) U.S. Cl. 455/556.1; 340/870.3

(57) ABSTRACT

Methods, systems, and apparatus, including computer programs encoded on a computer storage medium, include structures and techniques for integrating operations of consumer electronic devices. In one aspect, a method includes identifying a program operating on a second device; selecting a code set, from among multiple code sets, based on the identified program operating on the second device; modifying, at a first device, operation of an application installed on the first device by running the selected code set at the first device; and controlling a function of the program operating on the second device using the modified application on the first device.

### BACKGROUND

This specification relates to operations performed in conjunction with media content rendering on multiple consumer electronic devices.

Devices can be programmed for controlling other devices. For example, a remote control can be programmed and used for controlling a particular television. Similarly, a universal remote can be used for controlling multiple devices, such as televisions, stereos, and video players. With the advent of smart phones, developers have produced various computer applications for controlling devices. Upon downloading, installing, and running such an application, a user can use his or her smart phone to control a device. For example, the user can employ an application to control a television, another application to control a DVR (Digital Video Recorder), and so forth.

### SUMMARY

This specification describes technologies relating to integrating operation of consumer electronic devices, such as mobile phones, tablet computers, and television sets. In general, one innovative aspect of the subject matter described in this specification can be embodied in methods of integrating operation of a first device and a second device, the second device being distinct from the first device, the method including the actions of identifying a program operating on the second device; selecting a code set, from among multiple code sets, based on the identified program operating on the second device; modifying, at the first device, operation of an application installed on the first device by running the selected code set at the first device; and controlling a function of the program operating on the second device using the modified application on the first device. Other embodiments of this aspect include corresponding systems, apparatus, and computer programs, configured to perform the actions of the methods, encoded on computer storage devices.

These and other embodiments can each optionally include one or more of the following features. The method can include the actions of identifying a change in the program operating on the second device; selecting a different code set, from among the multiple code sets, based on the identified change in the program; modifying, at the first device, operation of the application on the first device by running the different code set at the first device; and controlling a different function on the second device using the newly modified application on the first device. Controlling the function of the program operating on the second device using the modified application on the first device can include controlling a television viewing application on the second device using code on the first device that effects a television remote control user interface; and controlling the different function on the second device using the newly modified application on the first device can include controlling a game application on the second device using code on the first device that effects a game controller user interface.

The program can be a first program, and identifying the change in the first program can include identifying a second program, different from the first program, operating on the second device. The first and second programs can run in an application execution environment installed on the second device, and the first device can identify programs operating on the second device using wireless peer-to-peer communications between the application installed on the first device and the application execution environment installed on the second device. The method can include downloading the code set over a network from a remote location. Moreover, the code set can include first bytecode, and the modifying can include replacing second bytecode with the first bytecode in the application installed on the first device.

In general, another aspect of the subject matter described in this specification can be embodied in systems that include a first device including a display, a processor, and a storage medium; a second device including a display, a processor, and a storage medium, the second device being distinct from the first device; the storage medium of the first device encoding an instance of an application execution environment; the storage medium of the second device encoding another instance of the application execution environment; and the instances of the application execution environment are configured to cause the first device or the second device to detect a change in an application running on the instance of the application execution environment on either the first device or the second device, reconfigure, in response to the detected change, an application running on the instance of the application execution environment on either the second device or the first device, and control the second device from the first device using the reconfigured application.

The instances of the application execution environment can be configured to communicate directly with each other using wireless signals, and can be configured to: cause the change to be detected in the application running on the instance of the application execution environment on the second device; and reconfigure, in response to the detected change, the application running on the instance of the application execution environment on the first device.

The instances of the application execution environment can he configured to communicate directly with each other using wireless signals, and can be configured to: cause the change to be detected in the application running on the instance of the application execution environment on the first device; and reconfigure, in response to the detected change, the application running on the instance of the application execution environment on the second device.

The change can be a change in function, including a change in a user interface for the function. The second device can include a television and the first device can include a mobile phone. The second device can include a tablet computer and the first device can include a mobile phone.

Particular embodiments of the subject matter described in this specification can be implemented so as to realize one or more of the following advantages. Multiple, disparate functions of a device, such as a television, can be controlled using a single application installed on a second device, without needing separate installed applications for the multiple, disparate functions. Changes in functionality of a device can be quickly identified, and a corresponding controller application can be adapted both in functionality and visual design to reflect the changes.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram showing an example of a system in which device operations are integrated.

FIG. 1B is a diagram showing an example of a program architecture, which can be used in the system of FIG. 1A.

FIG. 2 is a flowchart showing a process of integrating operations of a first device with a second device.

FIG. 3A is a diagram showing a process of reconfiguring an application on a first device to control a second device from the first device.

FIG. 3B is a diagram showing a process of reconfiguring an application on a second device to control the second device from a first device.

FIGS. 4A-4C are diagrams showing examples of reconfiguration of a mobile smart phone and a high definition television set.

Like reference numbers and designations in the various drawings indicate like elements.

### DETAILED DESCRIPTION

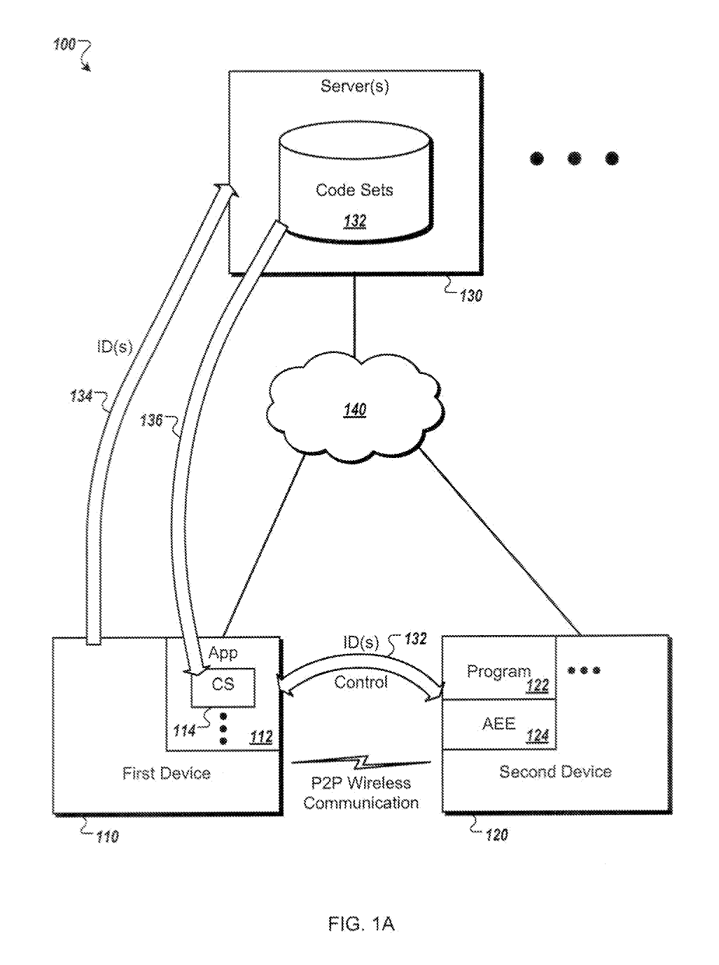

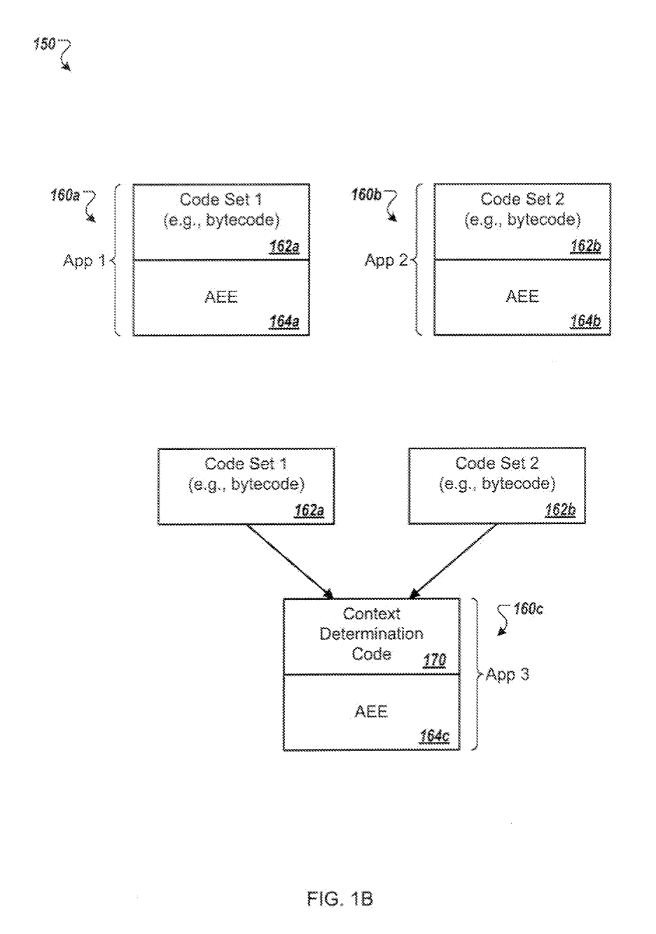

FIG. 1A is a diagram showing an example of a system 100 in which device operations are integrated. In general, the system 100 can include multiple distinct devices, such as a first device 110 and a second device 120, each configured to execute multiple software applications. A software application or a change to the application running on the second device 120 can be recognized. Based on the application or the change, a software application running on the first device 110 can be reconfigured. The reconfigured software application may be employed by a user of the first device 110 to control the second device 120.

In more detail, the first device 110 and the second device 120 may be any appropriate type of computing device (e.g., smart phones, PDAs, music players, e-book readers, tablet computers, laptop computers, desktop computers, video game consoles, network-enabled televisions (e.g., Internet-enabled televisions), or other stationary or portable devices). Among other components, for example, the devices 110, 120 may include one or more processors, computer readable storage mediums, input device(s) (e.g., keyboards, computer mice, joysticks, touch screens, motion sensors, microphones, and the like), output device(s) (e.g., display screens, speakers, and the like), and communications interfaces.

Storage mediums of the devices 110, 120 can encode instances of application execution environments. In the present example, the second device 120 can include an. instance of an application execution environment 124, and the first device 110 can include a context-aware application 112 supported by another instance of the application execution environment (not shown), such as ADOBE® FLASH® Player software or ADOBE® AIR® runtime environment, both by Adobe Systems Incorporated of San Jose, Calif.

The system 100 can include one or more servers 130. For example, the server(s) may be a single server, server cluster, sever farm, or other appropriate server configuration. The devices 110, 120, and the server(s) 130 can be communicatively coupled through one or more networks 140. The networks 140 may include a wired network, a wireless local area network (WLAN) or WiFi network, a private network such as an intranet, a public network such as the Internet, or any appropriate combination thereof. In some cases, the devices 110, 120 may communicate with each other indirectly, by passing messages via the server(s) 130. In some cases, only one of the devices 110, 120 may communicate with the server(s), and the devices 110, 120 may communicate directly with each other using wired or wireless protocols. For example, the devices 110, 120 can wirelessly communicate in a peer-to-peer environment using infrared signaling, Bluetooth, 802.11, or the like. In some implementations, such peer-to-peer communications can be built into the application execution environment. For example, Real Time Media Flow Protocol (RTMFP), a protocol developed by Adobe Systems Incorporated of San Jose, Calif., can be used to support sending data directly from one application execution environment to another, without passing data through the server(s) 130. In some cases, a connection with the server(s) 130 may be used to establish initial connections between instances of the application execution environment, and subsequent communication between the instances may be direct.

For purposes of illustration, a series of sample interactions are described here for integrating operation of the first device 110 and the second device 120. Although the sample interactions involve integrating operations of two devices, it will be appreciated that operations of three or more devices may also be integrated by the system 100. For example, two or more devices can be used to control a third device. As another example, three or more devices can control aspects of each of the other devices.

In the present example, a program 122 operating on the second device 120 can be identified. For example, the first device 110 may be a portable computer device, such as a smart phone, and the second device 120 may be a stationary computer device, such as an Internet-enabled television. In some implementations, the first device 110 and the second device 120 can each include communications ports (e.g., infrared, Bluetooth, 802.11, or the like) for sending and receiving signals including identification data. Thus, the first device 110 (e.g., the smart phone) and the second device 120 (e.g., the Internet-enabled television) may each recognize the presence of the other, as well as the presence and configuration of programs being run by the other. For example, as shown by communication arrow 132, one or more identifiers associated with the program 122 can be recognized by the first device 110. As shown by communication arrow 134, for example, upon recognizing the identifier(s), the first device 110 can provide the identifier(s) to the server(s) 130 via the network 140.

The server(s) can select a code set 114, from among multiple code sets 132, based on the identified program 122 operating on the second device 120. Alternatively, the first device 110 can select the code set 114 and send an identifier for this code set 114 to the server(s) 130 to download the selected code set, if not previously loaded on the first device 110. The code sets 132 can be used to implement many different types of applications (apps), such as video on demand apps, cooking show apps, gaming apps, etc. In some implementations, the code sets 132 can be indexed and stored by identifier. Upon receiving the identifier(s) from the first device 110, for example, the server(s) may use the identifier(s) to retrieve one or more corresponding code sets from the code sets 132. As shown by communications arrow 136, upon selecting the code set 114, for example, the set can be provided by the server(s) 130 to the first device 110.

At the first device 110, operation of the previously installed context-aware application 112 can be modified by running (e.g., “plugging in”) the selected code set 114. In general, modifications can include user interface related and functional changes to the operation of the context-aware application 112. For example, the code set 114 can include a new skin, providing a different look and feel to the application 112. As another example, the code set 114 can provide modified functionality, such as particular controls for interacting with the program 122. Thus, as the program 122 changes, an interface presented by the first device 110 can change.

In some implementations, modifications to the context-aware application 112 may be automatic. For example, the first device 110 can automatically detect changes to programs run by the second device 120, and the context-aware application 112 can automatically undergo modifications based on the changes. In some implementations, modifications may be dependent on user notification and consent. For example, a user of the first device 110 can be presented with a notification message related to a program change of the second device 120, and modifications to the context-aware application 112 can be performed upon consent of the user.

In some implementations, one or more of the code sets 132 may be stored on the first device 110. For example, as programs change on the second device 120, the first device 110 can detect the changes (e.g., by recognizing one or more identifiers) and can load locally stored (e.g., previously downloaded, or installed on manufacture) code sets 132 as needed.

A function of the program 122 operating on the second device 120 can be controlled using the modified application 112 on the first device. For example, as shown by communications arrow 132, once communications have been established between the first device 110 and the second device 120, command messages may be passed between the devices 110, 120. Thus, the first device 110 may be employed as a context-aware controller of the second device 120. For example, as programs and/or content changes on the second device 120 (e.g., an Internet-enabled television), the first device 110 (e.g., a smart phone) can recognize the change, download an appropriate code set over the network 140 from a remote location (or load the code set from local memory) to apply to the context-aware application 112, and use the modified application 112 to control functionality of the second device 120.

FIG. 1B is a diagram showing an example of a program architecture 150, which can be used in the system of FIG. 1A. In general, an application developer can generate multiple code sets which can be combined with application execution environments to form software applications that can be installed on one or more target computer devices. Additionally, the code sets can be provided (e.g., by a web server or peer device) to a context aware application that can receive and run different code sets to reconfigure itself at runtime.

In more detail, the program architecture 150 can include applications 160a and 160b. Each of the applications 160a, 160b can be supported by application execution environments to facilitate execution on one or more target devices. In some cases, a particular application execution environment may be configured to execute code sets for a particular device. For example, a smart phone may employ a particular application execution environment, and an Internet-enabled television may employ a different application execution environment.

In the present example, a first code set 162a can be combined (e.g., by a developer) with an application execution environment 164a to generate the application 160a, and a second code set 162b can be combined with an application execution environment 164b to generate the application 160b. In some implementations, the code sets 162a, 162b can include bytecode. For example, the code sets 162a, 162b (e.g., bytecode) can be executed on any appropriate computer device including an application execution environment, enabling the code sets 162a, 162b to be portable between devices.

The program architecture 150 can also include a context-aware application 160c which includes context determination code 170 supported by an application execution environment 164c. The context determination code 170 can be distributed to and installed on a target device, and can be used by the target device to select from multiple code sets at runtime. In the present example, the first code set 162a and the second code set 162b can each be accessible by the target device. For example, the code sets 162a, 162b can be provided by a web server, by a server on a local network, by a peer device, or by local storage of the target device.

In some implementations, the context-aware application 160c can replace one of the code sets 162a, 162b for another. For example, the context-aware application 160c may initially be used to execute the first code set 162a (e.g., bytecode for running a remote control application for a television-related application executed by another device). If the context changes (e.g., the television-related application is changed to a game-related application), the context-aware application 160c can recognize the change, and can replace the first code set 162a with the second code set 162b (e.g., bytecode for running a game control application for the game-related application executed by the other device). Thus, distinct sets of bytecode can be deployed as distinct applications. Additionally, a generic application (e.g., the context-aware application 160c) can replace one set of bytecode with another to reconfigure itself based on recognized context changes.

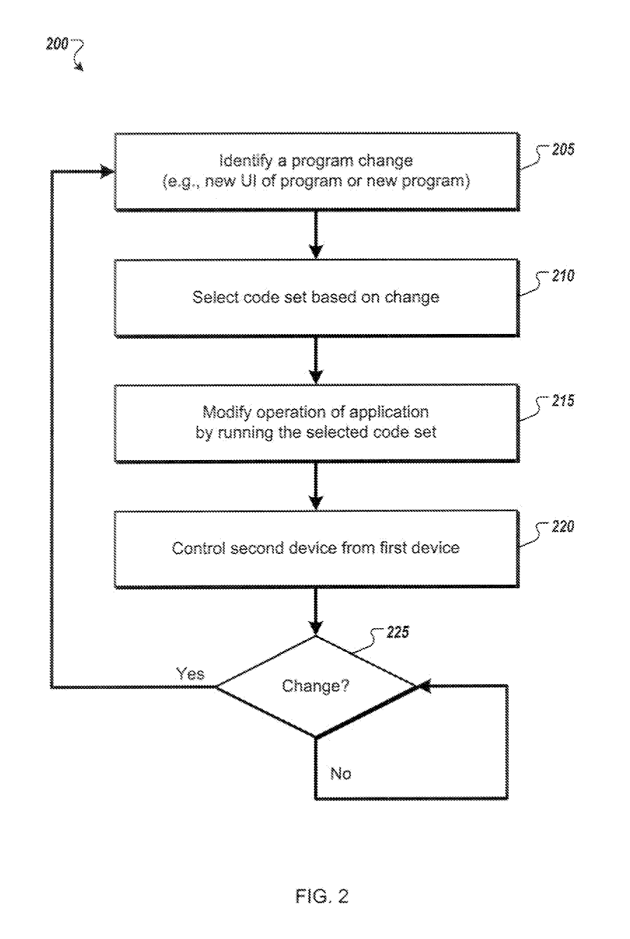

FIG. 2 is a flowchart showing a process 200 of integrating operations of a first device with a second device. In some implementations, the process 200 may be performed by the system 100 (shown in FIG. 1A), and will be described as such for clarity. In general, the process 200 can be performed using client/server techniques, peer-to-peer techniques, or a combination of techniques. Briefly, the process 200 includes identifying a program change, selecting a code set based on the change, modifying operation of an application by running the selected code set, and controlling a second device from a first device.

In more detail, a program change can be identified 205. For example, the first device 110 can identify a change in one or more programs operating on the second device 120. In some implementations, identifying program changes can include identifying contextual or functional changes in a single program. For example, the content-aware application 112 executed by the first device 110 may be used for navigating to various controls provided by the program 122 executed by the second device 120. If a user of the context-aware application 112 navigates to a search control associated with the program 122, for example, the program 122 may undergo a contextual or functional change (e.g., entering “search mode”), and the context-aware application 112 can recognize the change. In some implementations, identifying program changes can include identifying changes from one program to another. For example, if the second device 120 switches from a first program (e.g., a television-related application) operating on the device 120 to a second program (e.g., a game-related application) operating on the device 120, the context-aware application 112 can recognize the change. In some implementations, the first device 110 may identify programs operating on the second device 120 (and program changes) using wireless peer-to-peer communications between the application execution environment 124 and the context-aware application 112. For example, programs and program changes recognized by the context-aware application 112 can be based on IDs or commands provided by the application execution environment 124.

A code set can be selected based on the change 210. For example, the first device 110 can select a different code set than the code set presently executed by the context-aware application 112. The different code set can be selected from multiple code sets, such as the code sets 132, for example, or any code sets that may have been previously downloaded by the first device 110 and stored in memory.

Application operation can be modified by running the selected code set 215. For example, by running the selected code set, the context-aware application 112 may generate a modified interface for presentation to a device user. The modified interface can include controls and functionality particular to programs operating on the second device 120. In general, as programs operating on the second device 120 change (or switch), the interface presented to users by the first device 110 can be modified to correspond with the changes. For example, if the program 122 enters a particular mode (e.g., a “search” mode), the context-aware application 112 can recognize the change in mode and can present an interface (e.g., a “search” interface including a soft keyboard) associated with the mode.

The second device can be controlled from the first device 220. In some implementations, a different function on the second device 120 can be controlled using the newly modified context-aware application 112 on the first device 110. For example, prior to the identified change, the program 122 operating on the second device 120 may have been a television viewing application, and the content-aware application 112 may have run code on the first device 110 to effect a television remote control user interface. During the change, for example, the program 122 operating on the second device 120 may have switched to a game-related program, may have switched to a game-related mode, or may have added game-related functionality. After the change, and after the associated modification of the context-aware application 112, for example, the different (e.g., game-related) function may be controlled using the newly modified context-aware application 112, by running code on the first device 110 that effects a game controller interface.

In some implementations, control can be accomplished through local wireless peer-to-peer communication. As control and communication between the first device 110 and the second device 120 may be provided directly (i.e., without sending messages through a server), network traffic and lag can generally be avoided. Thus, program changes can be quickly identified, and corresponding application modifications can be quickly applied. In some implementations, multiple devices may be used to control the second device 120. For example, a group of users with context-aware applications running on devices may simultaneously interact with the program 122. Such a configuration may be used to enable multi-player gaming, for example.

If additional changes are identified 255, for example, the process 200 may repeat, selecting a code set based on the change, modifying operation of an application by running the selected code set, and controlling a second device from a first device.

In some implementations, operations performed within the process 200 may be performed by different devices than the devices in the previously presented examples. For example, although the identified program change may occur on the second device 120, the process step of identifying the change 205 can occur on either the first device 110 or the second device 120. Likewise, selecting the code set 210 can occur on either the first device 110 or the second device 120. With respect to FIG. 1A, a mirror implementation is possible, where the second device 120 contacts the server 130, selects and downloads the code set 114, and provides the code set 114 to the first device 110. In addition, the modifying operation 215 may occur on the second device 120 in some implementations.

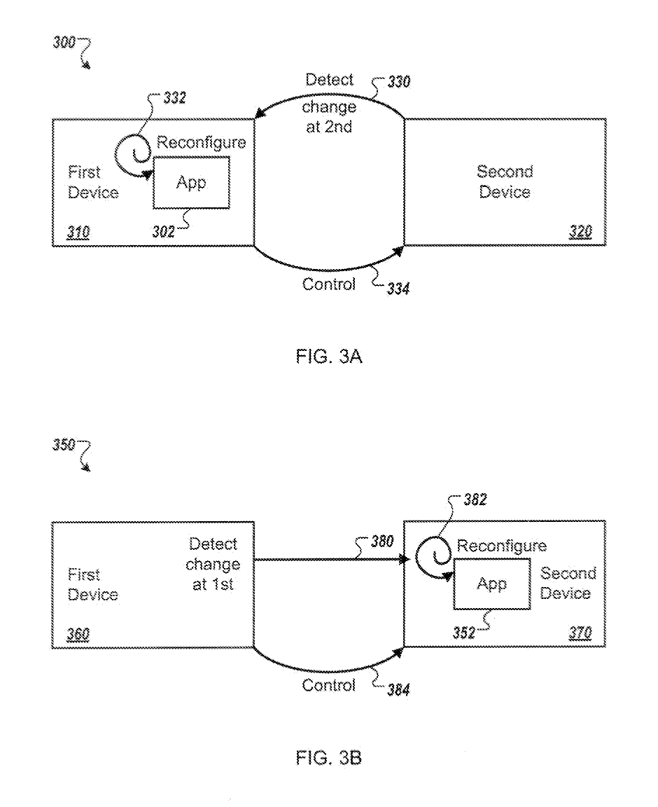

FIGS. 3A and 3B are diagrams showing processes for reconfiguring applications on a first or second device. In general, application execution environment instances running on a first device and a second device can be configured to cause the first device or the second device to detect a change in an application running on either the first device or the second device. In response to the detected change, the application running on either the second device or the first device can be reconfigured. Using the reconfigured application, the second device may be controlled from the first device.

FIG. 3A is a diagram showing a process 300 of reconfiguring an application 302 on a first device 310 to control a second device 320 from the first device 310. The devices 310, 320 can each include instances of an application execution environment (not shown) configured to communicate directly with each other using wireless signals.

As shown by process arrow 330, a change can be detected in an application running on the instance of the application execution environment on the second device 320. In some cases, a user of the second device 320 may initiate the change by interacting with the second device 320 or the application running on the device 320. For example, the user can switch the second device 320 from a television-viewing mode to a game-playing mode. As another example, the user can select or interact with a control (e.g., a search-related control) provided by the application running on the second device 320 to trigger a context change in the application. In some cases, an application change may be based on application content flow. For example, the application running on the device 320 can be used to present audiovisual content (e.g., a television program or movie). Certain sections of the content, for example, may be designed for user interaction (e.g., submission of feedback, requests for additional information, and the like), and upon presenting such sections, a context change can be triggered in the application running on the second device 320.

In some implementations, the change can be detected by the first device 310. For example, the first device 310 can periodically monitor the second device 320 for an identifier to associated with the application running on the second device 320. If the monitored identifier differs from a previously monitored identifier, for example, the first device 310 may recognize an application change. As another example, a user of the first device 310 can perform an action (e.g., pressing a button on the first device 310, pointing the first device 310 at the second device 320, or some other such action) that prompts the first device 310 to poll the second device 320 for information related to the application running on the second device 320, or the first device 310 can identify the change by actually causing the change in the application running on the second device 320.

In some implementations, the change can be detected by the second device 320. For example, the second device 320 can periodically monitor its status to identify a change to the application running on the second device 320. Upon detecting the change, for example, the second device 320 can broadcast a signal (e.g., including one or more identifiers) associated with the change that can be received by one or more other devices.

As shown by process arrow 332, in response to the detected change, the application 302 running on the instance of the application execution environment on the first device 310 can be reconfigured. For example, if an application running on the second device 320 is determined to have changed from a television-viewing mode to a game-playing mode, the application 302 may be reconfigured to present controls for interacting with the game. As another example, if it is determined that the application running on the second device 320 has entered a search-related mode (e.g., an input cursor has been placed in a search control), the application 302 may be reconfigured to present search-related controls (e.g., a soft keyboard). As another example, if it is determined that audiovisual content presented by the application running on the second device 320 is designed for user interaction, the application 302 may be reconfigured to enable a user of the first device 310 to interact with the content. For example, the application 302 can be reconfigured to present controls enabling the user to submit queries related to objects or individuals included in the content, to submit feedback (e.g., comments, ratings, voting, etc.) related to the content, or other interactions. As another example, in association with a television show or movie presented by the application running on the second device 320, the application 302 running on the first device 310 can present information about the current scene, information about products for purchase in the scene, and so forth. If the context of the audiovisual content presented by the second device 320 to changes, the application 302 running on the first device 310 may also change. For example, if the audiovisual content switches from the television show or movie to an advertisement, the application 302 running on the first device 310 can present content related to the advertisement, such as coupons, recipes, information about friends who have purchased advertised items, and other related information.

As shown by process arrow 334, functions of the application running on the second device 320 can be controlled using the reconfigured application 302 running on the first device 310. In general, a user of the first device 310 can interact with controls presented by the application 302 to control the application running on the second device 320. For example, game-related controls accessible on the first device 310 can be used to interact with a game-related application running on the second device 320. Similarly, for example, other sorts of controls accessible on the first device 310 can enable users to interact with content presented by the second device 320.

FIG. 3B is a diagram showing a process 350 of reconfiguring an application 352 on a second device 370 to control the second device 370 from a first device 360. The devices 360, 370 can each include instances of an application execution environment (not shown) configured to communicate directly with each other using wireless signals.

As shown by process arrow 380, a change can be detected in an application running on the instance of the application execution environment on the first device 360. In general, the change can be detected by either the first device 360 or the second device 370, using monitoring techniques and wireless communication techniques as described in reference to FIG. 3A.

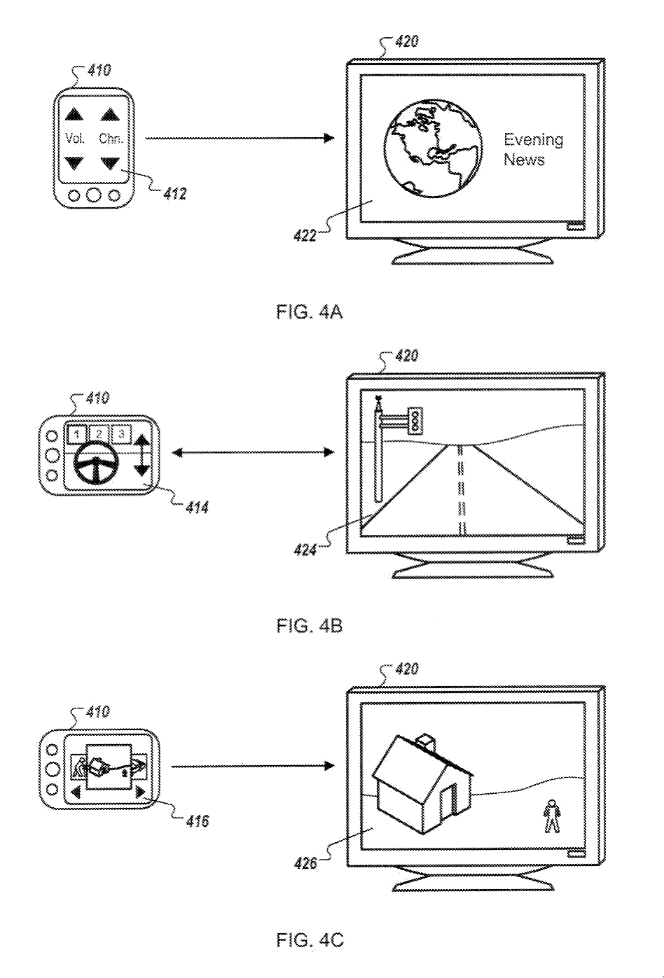

In some cases, a user of the first device 360 may initiate the change by interacting with the first device 360 or the application running on the device 360. For example, referring to FIG. 4A, a smart phone 410 (i.e., a first device) can initially display an interface 412 including one or more controls for controlling a television set 420 (i.e., a second device). As shown in FIG. 4C, the smart phone 410 may be rotated. For example, the smart phone 410 can detect the rotation (e.g., by referring to a built-in accelerometer) and can provide related data to an instance of the application execution environment on the phone 410.

Referring again to FIG. 3B, as shown by process arrow 380, information related to the detected change can be provided to the second device 370 (e.g., a television). For example, the information can include one or more identifiers or control codes indicating a change from one application (e.g., a television-control application) to another application (e.g., a photo-viewing application).

As shown by process arrow 382, in response to the detected change, the application 352 running on the second device 370 can be reconfigured. For example, the application 352 can run code for presenting an interface associated with the detected change. As shown in FIGS. 4A and 4C, for example, the television set 420 (i.e., the second device) can switch from presenting an interface 422 (e.g., a television display) to an interface 426 (e.g., a photo display). Correspondingly, the smart phone 410 (i.e., the first device) can switch from presenting the interface 412 (e.g., a television controller) to an interface 416 (e.g., a photo controller). For example, as gallery photos are displayed on the smart phone 410, the photos may be simultaneously displayed on the television set 420.

Referring again to FIG. 3B, as shown by process arrow 384, the reconfigured application 352 can be controlled by the application running on the instance of the application execution environment running on the first device 360. Although various examples have been presented related to using an application running on a smart phone to provide control to an application running on a television, other configurations are also possible. For example, an application running on a smart phone can be used to control an application running on a tablet computer. As another example, an application running on a tablet computer can be used to control an application running on a desktop computer.

FIGS. 4A-4C are diagrams showing examples of reconfiguration of a mobile smart phone 410 and a high definition television set 420. The series of FIGS. 4A-4C show a series of example transitions, where interfaces provided by one or more applications running on the smart phone 410 and interfaces provided by one or more applications running on the television set 420 undergo modifications to reflect application changes.

Referring to FIG. 4A, a user (not shown) can employ an application running on the smart phone 410 to control an application running on the television set 420. For example, the application running on the smart phone 410 can present the interface 412, including commonly used television controls (e.g., volume, channel selection, etc.). In some cases, the interface 412 can also include context-related controls (e.g., data entry controls, data retrieval controls, etc.) related to content presented by the application running on the television set 420.

Referring to FIG. 4B, the user can start a video game application on the television set 420. As shown, the application running on the television set 420 can display an interface 424 associated with the videogame application. In addition, the smart phone 410 can recognize the change, and the application running on the smart phone 410 can be modified to present an interface 414 (e.g., a video game controller). The interface 414 can include visual user interface design changes and changes to interaction paradigms. In addition to changing one or more visual user interface controls for the video game, the application running on the smart phone 410 may be modified to recognize different types of user interaction. For example, the application running on the smart phone 410 can be configured to control the application running on the television set 420 based on various forms of input received from the user, including touch screen input, motion input, voice input, and the like.

Referring to FIG. 4C, the user can start a photo display application on the smart phone 410. For example, to start the photo display application, the user may select an icon associated with the application from a menu. As shown, the application running on the smart phone 410 can display the interface 416 associated with the photo display application. In addition, the television set 420 can recognize the change, and the application running on the television set 420 can be modified to present the interface 426 (e.g., a photo display). The application running on the smart phone 410 can control the application running on the television set 420. For example, the user can employ the application running on the smart phone 410 to navigate through a photo gallery, and photos displayed on the smart phone 410 can be simultaneously displayed on the television set 420.

In addition to the previously presented example, other possibilities exist. For example, if the application running on the television set 420 were to present a cooking show for preparing a particular dish, the application running on the smart phone 410 may change to present a shopping list for the user to check off items included in the dish. If the user were to subsequently move to the kitchen, for example, the application running on the smart phone 410 may recognize the change in location and undergo an application change to present a video demonstration of how to prepare the dish.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer arc a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example to semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that arc described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of integrating operation of a first device and a second device, the second device being distinct from the first device, the method comprising:
identifying a program operating on the second device;
selecting a code set, from among multiple code sets, based on the identified program operating on the second device;
modifying, at the first device, operation of an application installed on the first device by running the selected code set at the first device; and
controlling a function of the program operating on the second device using the modified application on the first device.

2. The method of claim 1, comprising:
identifying a change in the program operating on the second device;
selecting a different code set, from among the multiple code sets, based on the identified change in the program;
modifying, at the first device, operation of the application on the first device by running the different code set at the first device; and
controlling a different function on the second device using the newly modified application on the first device.

3. The method of claim 2, wherein:
controlling the function of the program operating on the second device using the modified application on the first device comprises controlling a television viewing application on the second device using code on the first device that effects a television remote control user interface; and
controlling the different function on the second device using the newly modified application on the first device comprises controlling a game application on the second device using code on the first device that effects a game controller user interface.

4. The method of claim 2, wherein the program is a first program, and identifying the change in the first program comprises identifying a second program, different from the first program, operating on the second device.

5. The method of claim 4, wherein the first and second programs run in an application execution environment installed on the second device, and the first device identifies programs operating on the second device using wireless peer-to-peer communications between the application installed on the first device and the application execution environment installed on the second device.

6. The method of claim 1, comprising downloading the code set over a network from a remote location.

7. The method of claim 1, wherein the code set comprises first bytecode, and the modifying comprises replacing second bytecode with the first bytecode in the application installed on the first device.

8. A computer storage medium encoded with a computer program, the program comprising instructions that when executed by data processing apparatus cause the data processing apparatus to perform operations comprising:
identifying a program operating on a second device;
selecting a code set, from among multiple code sets, based on the identified program operating on the second device;
modifying, at a first device, operation of an application previously installed on the first device by running the selected code set at the first device; and
controlling a function of the program operating on the second device using the modified application on the first device.

9. The computer storage medium of claim 8, the operations comprising:
identifying a change in the program operating on the second device;
selecting a different code set, from among the multiple code sets, based on the identified change in the program;
modifying, at the first device, operation of the application on the first device by running the different code set at the first device; and
controlling a different function on the second device using the newly modified application on the first device.

10. The computer storage medium of claim 9, wherein:
controlling the function of the program operating on the second device using the modified application on the first device comprises controlling a television viewing application on the second device using code on the first device that effects a television remote control user interface; and
controlling the different function on the second device using the newly modified application on the first device comprises controlling a game application on the second device using code on the first device that effects a game controller user interface.

11. The computer storage medium of claim 9, wherein the program is a first program, and identifying the change in the first program comprises identifying a second program, different from the first program, operating on the second device.

12. The computer storage medium of claim 11, wherein the first and second programs run in an application execution environment previously installed on the second device, and the first device identifies programs operating on the second device using wireless peer-to-peer communications between the application previously installed on the first device and the application execution environment previously installed on the second device.

13. The computer storage medium of claim 8, the operations comprising downloading the code set over a network from a remote location.

14. The computer storage medium of claim 8, wherein the code set comprises first bytecode, and the modifying comprises replacing second bytecode with the first bytecode in the application previously installed on the first device.

15. A system comprising:
a first device comprising a display, a processor, and a storage medium;
a second device comprising a display, a processor, and a storage medium, the second device being distinct from the first device;
the storage medium of the first device encoding an instance of an application execution environment;
the storage medium of the second device encoding another instance of the application execution environment; and
the instances of the application execution environment are configured to
cause the first device or the second device to detect a change in an application running on the instance of the application execution environment on either the first device or the second device,
reconfigure, in response to the detected change, an application running on the instance of the application execution environment on either the second device or the first device, and
control the second device from the first device using the reconfigured application.

16. The system of claim 15, wherein the instances of the application execution environment are configured to communicate directly with each other using wireless signals, and are configured to:
cause the change to be detected in the application running on the instance of the application execution environment on the second device; and
reconfigure, in response to the detected change, the application running on the instance of the application execution environment on the first device.

17. The system of claim 15, wherein the instances of the application execution environment arc configured to communicate directly with each other using wireless signals, and are configured to:
cause the change to be detected in the application running on the instance of the application execution environment on the first device; and
reconfigure, in response to the detected change, the application running on the instance of the application execution environment on the second device.

18. The system of claim 15, wherein the change is a change in function, including a change in a user interface for the function.

19. The system of claim 15, wherein the second device comprises a television and the first device comprises a mobile phone.

20. The system of claim 15, wherein the second device comprises a tablet computer and the first device comprises a mobile phone.
